(19) United States
(12) Patent Application Publication
(10) Pub. No.: US 2011/0106424 A1
(43) Pub. Date: May 5, 2011

(54) Navigation method and human-machine interface apparatus thereof

(75) Inventors: Cheng-Jan Chi, Taipei (TW); Ren-Chyuan Luo, Taipei (TW); Chun-Chi Lai, Taipei (TW)

(73) Assignee: National Taiwan University

(21) Appl. No.: 12/684,880

(22) Filed: Jan. 8, 2010

(30) Foreign Application Priority Data
Oct. 30, 2009 (TW) 098136970

(51) Int. Cl. G01C 21/36

(52) U.S. Cl. 701/201

(57) ABSTRACT

A human-machine interface apparatus and a navigation method provide navigation information to users according to data provided by a location system. The human-machine interface apparatus comprises a pointing module and a microcontroller unit. The pointing module comprises a pointer. The microcontroller unit receives a first directing point, a second directing point and a third directing point obtained by the location system performing a vision-navigation operation, and deflects the pointer to a first angle, a second angle and a third angle when a vehicle location data reaches to the first, second and third directing points respectively. The third angle is larger than the second angle, and the second angle is larger than the first angle.

### CROSS-REFERENCE TO RELATED APPLICATIONS

This application is based upon and claims the benefit of priority from the prior Taiwanese Patent Application No. 098136970, filed Oct. 30, 2009, the entire contents of which are incorporated herein by reference.

### BACKGROUND

1. Field of the Invention

The present invention relates to a navigation method, and more particularly to a navigation method and a human-machine interface apparatus which guides a corner in multi stages.

2. Description of the Related Art

Global Positioning System (GPS) is a set of precise satellite navigation and positioning programs which the United Sates Department of Defense spends 20 years and more than 12 billion dollars, and starts to develop at 1973. The GPS started to emit at 1978 and formally position in all-weather and three-dimensional space at October 1993. The GPS is originally used to support the military aviation and aircraft. Now, the GPS has been used in civilian to cause some revolutionary changes in the life application thereof. For example, vehicle and vessel in moving can employ the GPS to determine arrival time and route of destination. Ambulance may task more urgent and effective paramedic implementation. Driver of vehicle can know current location and how to reach the destination through electrical map. Since the GPS has a precise three-dimensional space positioning function, it can be applied to the aircraft navigation and the collision-avoidance system and the precise zero-visibility landing system of the airport control tower. The United States Forest Service Department confirms over 130 tasks according to the capacities and the possible applications of the GPS at 1992 (Greer, 1993).

The current GPS in vehicle on the market generally includes a screen configured for displaying the current location of the user in the map and recommending a vehicle route and directions of the destination. Refer to FIGS. 6A and 6B, which are schematic views of a conventional vision-navigation operation. The conventional navigation system defines navigation points A, B, C, D on a turning point of a predetermined route, reminds the user of the navigation system distances between the current location of the user and the turning point by voice and reminds to prepare to turn left when it is at the navigation points A and B. Simultaneously, in FIG. 6B, the pointer points to a forward direction at the navigation points A and B, that is, the pointer points to the front of the current road.

Therefore, the pointer is not deflected and still points to the forward direction at the navigation points A and B. When the vehicle reaches the navigation point C (that is the turning point in the map of the navigation system), the pointer is anticlockwise deflected to 90 degrees momentarily for reminding the user it should be turned to left. Furthermore, at the navigation point D of FIG. 6B, the pointer is clockwise deflected to 90 degrees momentarily for pointing to a forward direction and reminding the user continuously advancing. The conventional navigation system employs the pointer to remind the user the forward directions, but it suddenly turns the pointer to the left or the right at the turning pointer. However, the above design is not coincided with the actual vehicle trace of the driver since the driver has turned the steering-wheel anticlockwise between the navigation points B and C, and turned the steering-wheel clockwise after reaching the navigation point C to correct the tires. Therefore, the conventional pointer navigation mode is not coincided with the driving behavior of the driver. More particularly, it is very dangerous and is prone to take place incidents for the novice of the driver.

### BRIEF SUMMARY

The present invention relates to a navigation method which can provide a definite pointing denotation when a vehicle turns.

The present invention also relates to a human-machine interface apparatus which employs a pointer to provide a pointing denotation in multi stages such that a direction of the pointer is close to the human vision condition.

A navigation method in accordance with an exemplary embodiment of the present invention is suitable for a pointing module of a human-machine interface. The pointing module comprises a pointer. The navigation method comprises step of providing a predetermined route; step of performing a vision-navigation operation when a distance between a vehicle location data and a turning point of the predetermined route reaches a turning navigation distance; step of obtaining a first directing point, a second directing point and a third directing point according to the vision-navigation operation; step of deflecting the pointer to a first angle when the vehicle location data reaches the first directing point; step of deflecting the pointer to a second angle when the vehicle location data reaches the second directing point; step of deflecting the pointer to a third angle when the vehicle location data reaches the third directing point. The third angle is larger than the second angle, and the second angle is larger than the first angle.

In a preferable exemplary embodiment of the present invention, a corner of actual roads or the turning point of the predetermined route is regarded as the third directing point when performing the vision-navigation operation.

In a preferable exemplary embodiment of the present invention, the third angle intersected with roads of the vehicle location data is a right angle.

In a preferable exemplary embodiment of the present invention, the pointer is deflected to the first angle and the second angle with a same-angle deflection.

In a preferable exemplary embodiment of the present invention, the navigation method further comprises obtaining a fourth directing point according to the vision-navigation operation; and deflecting the pointer to a fourth angle when the vehicle location data reaches the fourth directing point.

In a preferable exemplary embodiment of the present invention, a point intersected by a straight line between the second directing point and the fourth directing point, and a corner of actual roads is an analog directing point.

In a preferable exemplary embodiment of the present invention, an angle intersected by a straight line between the first directing point and the analog directing point, and a road of the vehicle location data is the first angle.

In a preferable exemplary embodiment of the present invention, an angle intersected by a straight line between the second directing point and the analog directing point, and a road of the vehicle location data is the second angle.

In a preferable exemplary embodiment of the present invention, the fourth angle and the third angle are different from 90 degrees.

In a preferable exemplary embodiment of the present invention, the deflected first angle makes the pointer point to the fourth directing point when the vehicle location data reaches the first directing point.

In a preferable exemplary embodiment of the present invention, the deflected second angle makes the pointer point to the fourth directing point when the vehicle location data reaches the second directing point.

A human-machine interface apparatus in accordance with another exemplary embodiment of the present invention is configured for providing navigation information to a user according to a vehicle location data provided by a location system. The human-machine interface apparatus comprises a pointing module and a microcontroller unit. The pointing module comprises a pointer. The microcontroller unit is configured for receiving the vehicle location data provided by the location system, performing a vision-navigation operation to obtain a first directing point, a second directing point and a third directing point, and deflecting the pointer to a first angle, a second angle and a third angle when the vehicle location data reaches the first directing point, the second directing point and the third directing point respectively. The third angle is larger than the second angle, and the second angle is larger than the first angle.

In a preferable exemplary embodiment of the present invention, the human-machine interface apparatus further comprises a directing-lamp module. The directing-lamp module is electrically coupled to the microcontroller unit and comprises a plurality of direction lamps and a light-penetrating board. The light-penetrating board covers on the direction lamps.

A navigation method in accordance with other exemplary embodiment of the present invention is suitable for a pointing module of a human-machine interface apparatus. The pointing module comprises a pointer. The navigation method comprises step of providing a predetermined route; step of performing a vision-navigation operation when a distance between a vehicle location data and a turning point of the predetermined route reaches a turning navigation distance; obtaining a plurality of directing points according to the vision-navigation operation; step of and deflecting the pointer to an angle when the vehicle location data reaches each of the directing points. A deflection angle of a fore directing point is larger than a deflection angle of a back directing point which is adjacent to the fore directing point.

A human-machine interface apparatus in accordance with other exemplary embodiment of the present invention is configured for providing navigation information to a user according to a vehicle location data provided by a location system. The human-machine interface apparatus comprises a pointing module and a microcontroller unit. The pointing module comprises a pointer. The microcontroller unit is configured for receiving the vehicle location data provided by the location system, performing a vision-navigation operation to obtain a plurality of directing points, and deflecting the pointer to an angle when the vehicle location data reaches each of the directing points. A deflection angle of a fore directing point is larger than a deflection angle of a back directing point which is adjacent to the fore directing point.

The present invention employs the vision-navigation operation, thus it can makes the pointer provide a definite pointing denotation when the vehicle reaches the turning navigation distance, and makes the pointer provide a pointing denotation in multi stages with different angles which is more close to the human vision condition, such that the driver can favorably perform the turning operation.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a circuit block view of a human-machine interface apparatus in accordance with an exemplary embodiment of the present invention.

FIG. 2 is a flow chart of a navigation method in accordance with an exemplary embodiment of the present invention.

FIG. 3A is a schematic view of a vision-navigation operation in accordance with an exemplary embodiment of the present invention.

FIG. 3B is a schematic view of a pointer as shown in FIG. 3A deflecting.

FIG. 4A is a schematic view of a vision-navigation operation in accordance with another exemplary embodiment of the present invention.

FIG. 4B is a schematic view of a pointer as shown in FIG. 4A deflecting.

FIG. 5 is a schematic view of a vision-navigation operation in accordance with other exemplary embodiment of the present invention.

FIG. 6A is a schematic view of a conventional vision-navigation operation.

FIG. 6B is a schematic view of a pointer as shown in FIG. 6A deflecting.

### DETAILED DESCRIPTION

Reference will now be made to the drawings to describe exemplary embodiments of the present navigation method and the present human-machine interface apparatus thereof in detail. The following description is given by way of example, and not limitation.

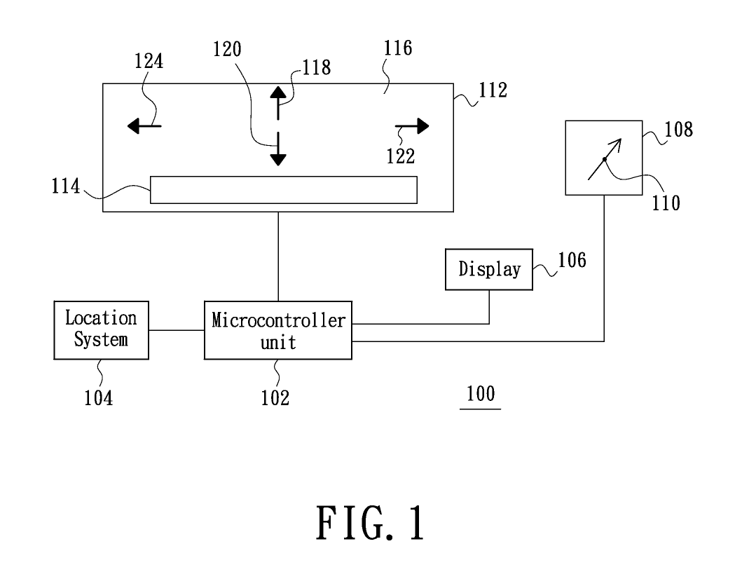

Refer to FIG. 1, which is a circuit block view of a human-machine interface apparatus in accordance with an exemplary embodiment of the present invention. The human-machine interface apparatus 100 includes a microcontroller unit 102, a location system 104, a display 106, a pointing module 108 and a directing-lamp module 112. This exemplary embodiment disposes the location system 104 in the human-machine interface apparatus 100 as an example to describe the present invention. However, in actual, the location system 104 may be not disposed in the human-machine interface apparatus 100, and only be communicated with the human-machine interface apparatus 100 by the wire mode or the wireless mode.

The location system 104 is configured for receiving location signals transmitted from GPS, decoding the location signals into a current vehicle location data, and then outputting the vehicle location data to the microcontroller unit 102. It is obvious for persons skilled in the arts that the microcontroller unit 102 may be used to decode the current vehicle location data.

The microcontroller unit 102 is electrically coupled to the location system 104 and the display 106 for receiving the vehicle location data. The microcontroller unit 102 cooperates the vehicle location data with a map, and then displays on the display 106. After enabling the human-machine interface apparatus 100, the microcontroller unit 102 also can receive data of a departure place and a destination inputted by user. The microcontroller unit 102 plans routes according to the departure place and the destination to obtain a predetermined route.

In a preferable exemplary embodiment of the present invention, the display 106 may be a liquid crystal display or other-type display, and is assembled in the vehicle where the user is prone to watch, such as on an instrument board or beside a rearview mirror. The display 106 is configured for displaying auxiliary information in relation to roads, directions and the destination. When being safe and convenient, the user can view the information displayed on the display 106.

The directing-lamp module 112 is electrically coupled to the microcontroller unit 102, and includes a plurality of direction lamps 118, 120, 122 and 124, and a light-penetrating board 116. Preferably, the direction lamps 118, 120, 122 and 124 are light emitting diodes (LED) respectively to decrease the power consumption thereof. The light-penetrating board 116 has arrowheads printed thereon, and the arrowheads cover on the direction lamps 118, 120, 122 and 124 respectively, such that the light-penetrating board 116 is prone to be disassembled when it needs to be repaired or change the direction lamps. Of course, the directing-lamp module 112 also may include a fix portion, and the fix portion may be an attaching device or a clamp device (not shown), such that the directing-lamp module 112 can be fixed in the vehicle, such as on the instrument board or on a sun-shield plate. In here, to avoid describing unclearly since the figure is too complex, the exemplary embodiment employs four direction lamps as an example to describe the present invention. However, in actual, the directing-lamp module 112 may includes more than four direction lamps to cooperate with the pointing module 108.

The human-machine interface apparatus 100 may further includes a horse-race lamp 114 configured for providing some additional information. For example, when the microcontroller unit 102 controls the pointer 110 to point to a goal which should be noted, or when the microcontroller unit 102 controls the directing-lamp module 112 to send a flicker alert, the horse-race lamp 114 may provide corresponding literal information to the user. The goal which should be noted, includes navigation turning points before reaching the actual location of the destination, road directing devices, traffic-accident happening points and locations of predetermined objects which should be noted by the user, etc.

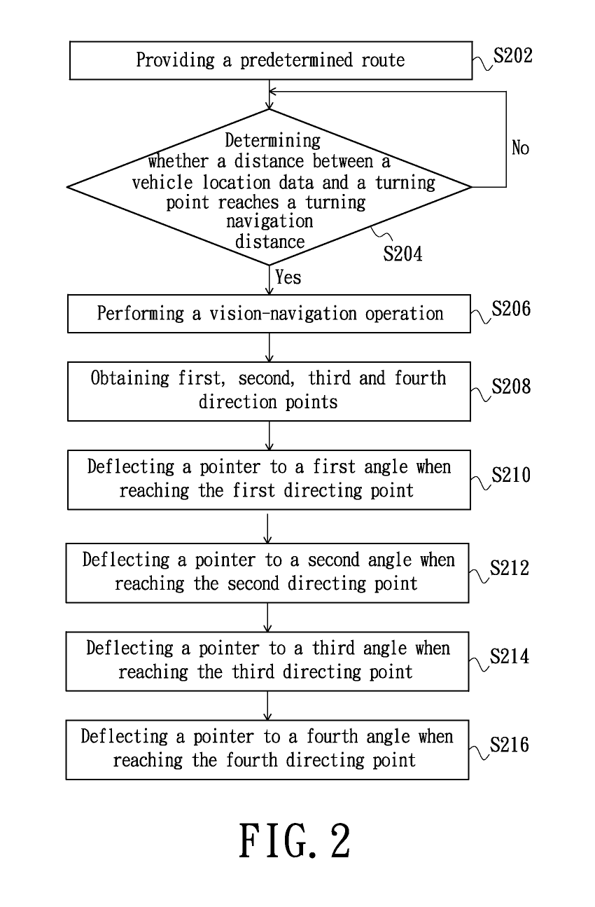

The microcontroller unit 102 is also electrically coupled to the pointing module 108 to control the turn of the pointer 110 of the pointing module 108. In this exemplary embodiment, the microcontroller unit 102 determines the turn of the pointer according to the predetermined route and the location of the vehicle. The turn of the pointer will be described in following by cooperating a navigation method as shown in FIG. 2.

Refer to FIG. 2, which is a flow chart of a navigation method in accordance with an exemplary embodiment of the present invention. Referring to FIGS. 1 and 2 together, after enabling the human-machine interface apparatus 100, the user may operate the display 106 to input the departure place and the destination, and the microcontroller unit 102 calculates the predetermined route according to the departure place and the destination by cooperating the map (a step S202). The predetermined route is displayed on the display 106. Alternatively, the user may not input the departure place, and the location system 104 can regard the current location of the vehicle as the departure place. However, the present invention is not limited in this.

When the vehicle moves along the predetermined route, the location system 104 will continuously receives the location signals, convert the location signals into the vehicle location data, and output the vehicle location data to the microcontroller unit 102. The microcontroller unit 102 determines how far is between the vehicle and the turning point of the predetermined route according to the vehicle location data (a step S204), and performs a vision-navigation operation when the distance therebetween is not larger than a turning navigation distance (a step S206). On the contrary, when the distance between the vehicle and the turning point is larger than the turning navigation distance, the navigation method returns to perform the step S204.

The microcontroller unit 102 obtains a first directing point, a second directing point, a third directing point and a fourth directing point according to the vision-navigation operation (a step S208). The first directing point and the second directing point are both located at a road where the vehicle still moves, such that it will make the driver have a sufficient prepare time. The fourth directing point is located at a road after the turning point, and the third directing point is located at the turning point.

In a preferable exemplary embodiment of the present invention, the vision-navigation operation may be performed after planning the predetermined route. If the driver does not drive the vehicle along the predetermined route in drive, the microcontroller unit 102 will re-plan another predetermined route, and also re-perform the vision-navigation operation.

After obtaining the first to fourth directing points, the microcontroller unit 102 determines whether the vehicle reaches the first directing point according to the vehicle location data. When the vehicle location data represents the vehicle has reached the first directing point, the microcontroller unit 102 outputs a deflection signal to the pointing module 108, such that the pointer is deflected to a first angle (a step S210). The first angle is defined by a forward direction of the vehicle and a turned direction of the pointer. For example, if the pointer should turn to the left, the pointer is anticlockwise deflected from a direction of twelve o'clock; and if the pointer should turn to the right, the pointer is clockwise deflected from the direction of twelve o'clock.

When the vehicle passes through the first directing point and does not reach the second directing point, the pointer may be fixed at the deflected first angle. Until the vehicle reaches the second directing point, the microcontroller unit 102 outputs another deflection signal to the pointing module 108 to deflect the pointer to a second angle from the first angle. Alternatively, the operation of the pointer is deflected from the first angle to the second angle may be performed by following steps. The microcontroller unit 102 continuously obtains current speeds of the vehicle according to the vehicle location data, calculates distances between the vehicle and the second directing point according to the current speeds, and continuously outputs deflection signals to the pointing module 108 to slightly deflect the pointer with little angles in sequence. Thus, the pointer is deflected to the second angle when the vehicle reaches the second directing point (a step S212).

Similarly, when the vehicle passes through the second directing point and does not reach the third directing point, the pointer may operate as described in the above description. For example, the pointer is deflected momentarily to a third angle from the second angle when the vehicle reaches the third directing point, or the pointer is slightly deflected with little angles to the third angle from the second angle in sequence (a step S214). When the vehicle reaches the third directing point, the pointer points to a direction of a road where the vehicle should turn (that is perpendicular to the road where the first and second directing points are located). For example, when the vehicle turns to the left, the pointer points to a direction of nine o'clock; and when the vehicle turns to the right, the pointer points to a direction of three o'clock.

When the vehicle passes through the third directing point and does not reach the fourth directing point, the pointer may be kept at the third angle or be slightly deflected with little angles to a fourth angle by the method as described of the above description (a step S216). When the vehicle reaches the fourth directing point, the pointer will return to point to the direction of twelve o'clock since the vehicle has moved in the road where it should turn.

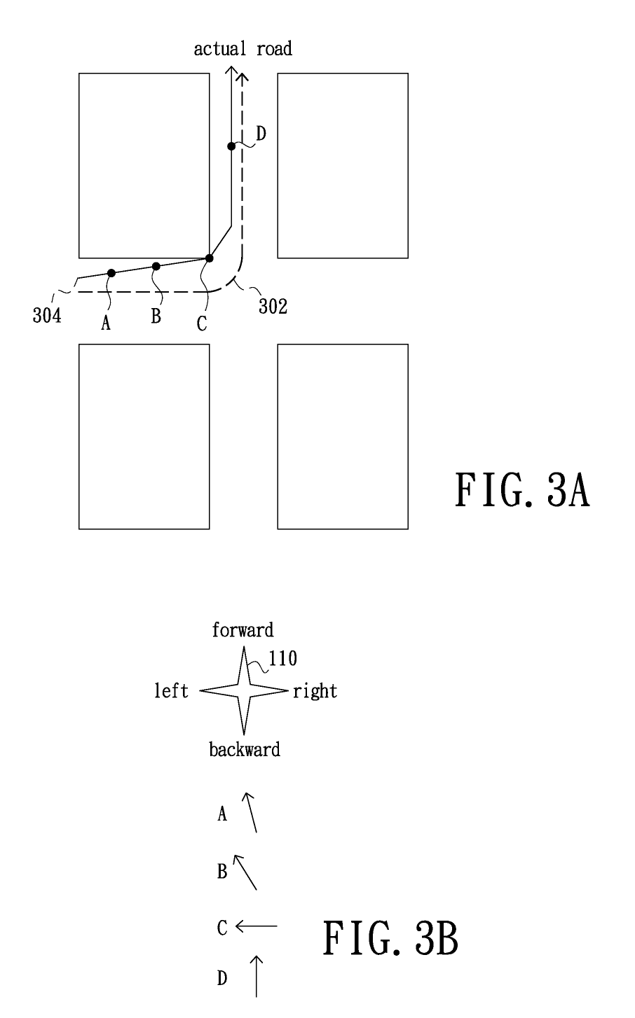

Refer to FIGS. 3A and 3B, which is a schematic view of a vision-navigation operation in accordance with an exemplary embodiment of the present invention and a schematic view of a pointer of FIG. 3A deflecting. In this exemplary embodiment, the turning point of the actual roads is regarded as the third directing point C, and the first directing point A and the second directing point B are predetermined distances of the human-machine interface apparatus 100 (linear distances far away from the turning point). A broken line 302 of FIG. 3A is a trace route when the vehicle turns (called as a vehicle route in following), and a real line 304 is a navigation route.

In FIG. 3A, the vision-navigation operation links the directing point A to the directing point C, and the second directing point B is also located on a straight line between the directing point A and the directing point C. Therefore, the deflection signal outputted from the microcontroller unit 102 will anticlockwise deflect the pointer with 30 degrees when the vehicle reaches the directing point A, and will anticlockwise deflect the pointer with 30 degrees continuously when the vehicle reaches the directing point B. That is, as shown in FIG. 3B, the first angle of the directing point A is 30 degrees, and the second angle of the directing point B is 60 degrees. When the vehicle reaches the directing point C, the pointer points to the direction of nine o'clock (turn to the left). When the vehicle reaches the directing point D, the pointer is clockwise deflected with 90 degrees to return to the direction of twelve o'clock (forward).

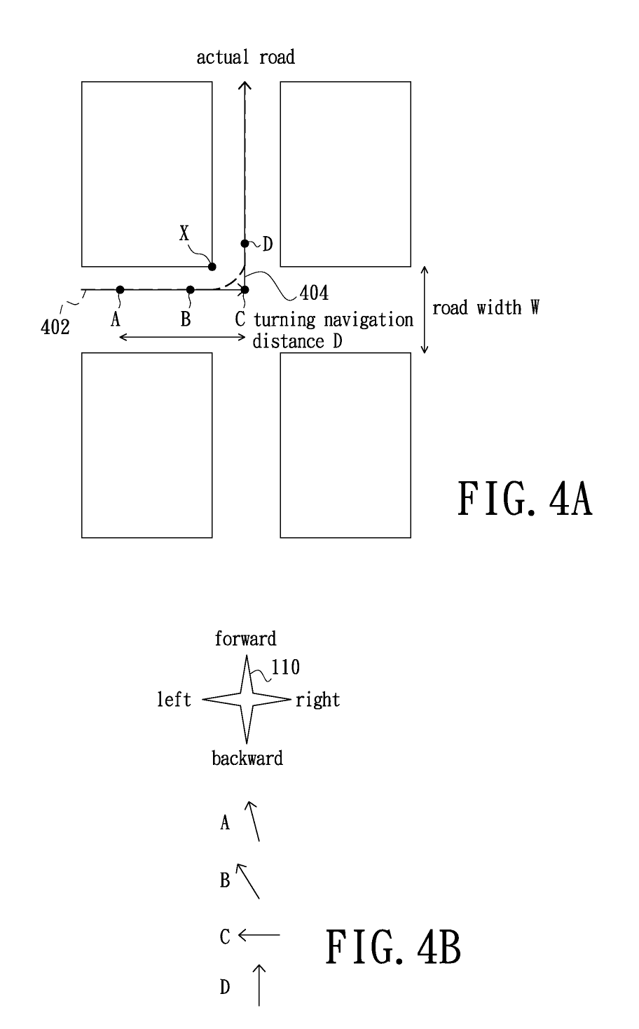

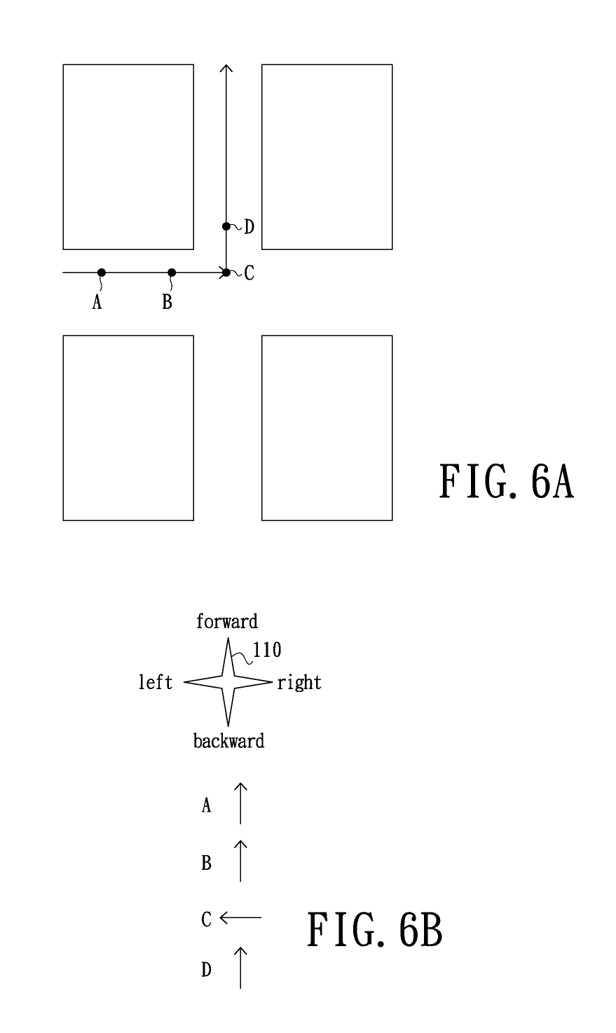

Refer to FIGS. 4A and 4B, which are a schematic view of a vision-navigation operation in accordance with another exemplary embodiment of the present invention and a schematic view of a pointer as shown in FIG. 4A deflecting. In this exemplary embodiment, the locations of the directing points A, B, C, D are same to those of the conventional art (as shown in FIG. 6A). A broken line 402 of FIG. 4A is a trace route when the vehicle turns (called as a vehicle route in following), and a real line 404 thereof is a navigation route. The vehicle route 402 at the directing points A, B, D is coincided with the navigation route 404.

In FIG. 4A, the vision-navigation operation links the directing points B and C to be a straight line, links the directing points B and D to be a straight line, and links the directing points C and D to be a straight line, so as to form a triangle. In this triangle, an intersecting point is formed by intersecting the straight line between the directing points B and D, and the turning point of the actual roads, and the intersecting point is defined as an analog directing point X.

Therefore, as shown in FIG. 4B, when the vehicle reaches the directing point A, the microcontroller unit 102 outputs the deflection signal to deflect the pointer 110 to the first angle, and the pointer points to a direction which points to the analog directing point X. When the vehicle reaches the directing point B, the microcontroller unit 102 outputs the deflection signal to deflect the pointer 110 to the second angle, and the pointer points to another direction which also points to the analog directing point X. When the vehicle reaches the directing point C, the pointer points to the direction of nine o'clock (turn to the left). When the vehicle reaches the directing point D, the pointer is clockwise deflected with 90 degrees to return to point to the direction of twelve o'clock (forward).

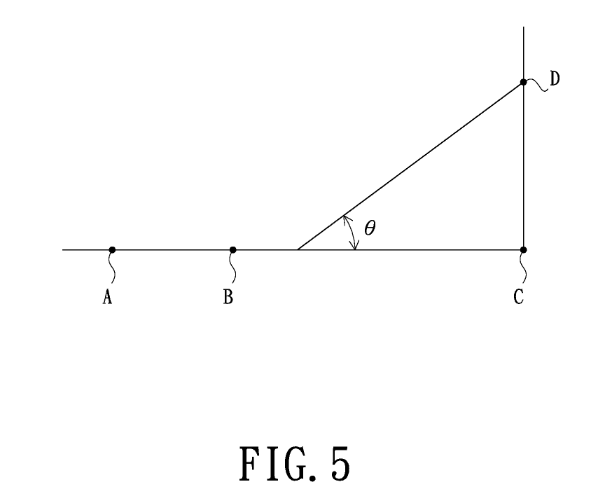

Refer to FIG. 5, which is a schematic view of a vision-navigation operation in accordance with other exemplary embodiment of the present invention. In this exemplary embodiment, the locations of the directing points A, B, C, D are same to those of the conventional art (as shown in FIG. 6A).

In FIG. 5, after the vehicle passes through the directing point A, it may employ the distance between the vehicle location data and the directing point C for determining the deflection angle of the pointer 110. That is, if the distance between the vehicle location data and the directing point C is larger, an angle ⊖ as shown in FIG. 5 is smaller. Before the directing point A, the pointer 110 points to the forward direction, and at the directing point C, the pointer points to the direction of turning to the left. Therefore, if the distance between the directing point A and the directing point C is 100 meters, the microcontroller unit 102 anticlockwise deflects the pointer with 9 degrees when the vehicle goes forward every 10 meters.

In a preferable exemplary embodiment of the present invention, if the speed of the vehicle is faster, the deflection speed of the pointer is faster.

In addition, as shown in FIG. 5, when the vehicle passes through the directing point A and does not reach the directing point C, the vision-navigation operation may be performed such that the microcontroller unit 102 makes the pointer continuously point to the directing point D, that is the angle ⊖ as shown in FIG. 5.

The first angle ⊖ at the directing point A is not same to the second angle ⊖ at the directing point B. In other words, the first angle ⊖ is smaller than the second angle ⊖. When the vehicle reaches the directing point C, the pointer points to the direction of nine o'clock (that is pointing to the directing point D). When the vehicle reaches the directing point D, the pointer is clockwise deflected with 90 degrees to return to point to the direction of twelve o'clock.

The preferable exemplary embodiment of the present invention employs the turning angle of turning to the left or the right to be the right angle as an example to describe the present invention. However, the turning angle in actual may be not the right angle, and it also can employ the design of the present invention or the vision-navigation operation of the present invention to obtain the proximate direction of the pointer.

In a preferable exemplary embodiment of the present invention, the amount of the directing points is not limited to be three or four directing points as described in the above description. The present invention makes the deflection angle of the pointer 110 larger when the distance between the vehicle and the turning point is shorter.

In summary, the navigation method and the human-machine interface apparatus of the present invention employs the vision-navigation operation, thus it can makes the pointer provide a definite pointing denotation when the vehicle reaches the turning navigation distance, and makes the pointer provide a pointing denotation in multi stages with different angles which is more close to the human vision condition, such that the driver can favorably perform the turning operation.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A navigation method suitable for a pointing module of a human-machine interface, the pointing module comprising a pointer, and the navigation method comprising:
providing a predetermined route;
performing a vision-navigation operation when a distance between a vehicle location data and a turning point of the predetermined route reaches a turning navigation distance;
obtaining a first directing point, a second directing point and a third directing point according to the vision-navigation operation;
deflecting the pointer to a first angle when the vehicle location data reaches the first directing point;
deflecting the pointer to a second angle when the vehicle location data reaches the second directing point; and
deflecting the pointer to a third angle when the vehicle location data reaches the third directing point;
wherein the third angle is larger than the second angle, and the second angle is larger than the first angle.

2. The navigation method as claimed in claim 1, wherein a corner of actual roads is regarded as the third directing point when performing the vision-navigation operation.

3. The navigation method as claimed in claim 2, wherein the third angle is an angle intersected by roads of the vehicle location data, and is a right angle.

4. The navigation method as claimed in claim 3, wherein the pointer is deflected to the first angle and the second angle with a same-angle deflection.

5. The navigation method as claimed in claim 1, wherein the turning point of the predetermined route is regarded as the third directing point when performing the vision-navigation operation.

6. The navigation method as claimed in claim 5, wherein the third angle is an angle intersected by roads of the vehicle location data and is 90 degrees.

7. The navigation method as claimed in claim 6, further comprising:
obtaining a fourth directing point according to the vision-navigation operation; and
deflecting the pointer to a fourth angle when the vehicle location data reaches the fourth directing point.

8. The navigation method as claimed in claim 7, wherein a point intersected by a straight line between the second directing point and the fourth directing point, and a corner of actual roads is an analog directing point.

9. The navigation method as claimed in claim 8, wherein an angle intersected by a straight line between the first directing point and the analog directing point, and a road of the vehicle location data is the first angle.

10. The navigation method as claimed in claim 8, wherein an angle intersected by a straight line between the second directing point and the analog directing point, and a road of the vehicle location data is the second angle.

11. The navigation method as claimed in claim 7, wherein the fourth angle and the third angle are different from 90 degrees.

12. The navigation method as claimed in claim 1, wherein the third angle is an angle between roads of the vehicle location data, and is 90 degrees.

13. The navigation method as claimed in claim 12, further comprising:
obtaining a fourth directing point according to the vision-navigation operation; and
deflecting the pointer to a fourth angle when the vehicle location data reaches the fourth directing point.

14. The navigation method as claimed in claim 13, wherein the deflected first angle makes the pointer point to the fourth directing point when the vehicle location data reaches the first directing point.

15. The navigation method as claimed in claim 13, wherein the deflected second angle makes the pointer point to the fourth directing point when the vehicle location data reaches the second directing point.

16. The navigation method as claimed in claim 12, wherein the fourth angle and the third angle are different from 90 degrees.

17. A human-machine interface apparatus configured for providing navigation information to a user according to a vehicle location data provided by a location system, the human-machine interface apparatus comprising:
a pointing module comprising a pointer; and
a microcontroller unit configured for receiving the vehicle location data provided by the location system, performing a vision-navigation operation to obtain a first directing point, a second directing point and a third directing point, and deflecting the pointer to a first angle, a second angle and a third angle when the vehicle location data reaches the first directing point, the second directing point and the third directing point respectively;
wherein the third angle is larger than the second angle, and the second angle is larger than the first angle.

18. The human-machine interface apparatus as claimed in claim 17, further comprising a directing-lamp module, wherein the directing-lamp module is electrically coupled to the microcontroller unit and comprises a plurality of direction lamps and a light-penetrating board, and the light-penetrating board covers on the direction lamps.

19. The human-machine interface apparatus as claimed in claim 17, wherein a corner of actual roads is regarded as the third directing point when the location system performs the vision-navigation operation.

20. The human-machine interface apparatus as claimed in claim 19, wherein the third angle is an angle between roads of the vehicle location data and is a right angle.

21. The human-machine interface apparatus as claimed in claim 20, wherein the pointer is deflected to the first angle and the second angle in sequence with a same-angle deflection.

22. The human-machine interface apparatus as claimed in claim 17, wherein the turning point of the predetermined route is regarded as the third directing point when the location system performs the vision-navigation operation.

23. The human-machine interface apparatus as claimed in claim 22, wherein the third angle is an angle between roads of the vehicle location data and is 90 degrees.

24. The human-machine interface apparatus as claimed in claim 23, wherein the location system further obtains a fourth directing point according to the vision-navigation operation, and the microcontroller unit deflects the pointer to a fourth angle when the vehicle location data reaches the fourth directing point.

25. The human-machine interface apparatus as claimed in claim 24, wherein a point intersected by a straight line between the second directing point and the fourth directing point, and a corner of actual roads is regarded as an analog directing point.

26. The human-machine interface apparatus as claimed in claim 25, wherein an angle intersected by a straight line between the first directing point and the analog directing point, and a road of the vehicle location data is the first angle.

27. The human-machine interface apparatus as claimed in claim 25, wherein an angle intersected by a straight line between the second directing point and the analog directing point, and a road of the vehicle location data is the second angle.

28. The human-machine interface apparatus as claimed in claim 24, wherein the fourth angle and the third angle are different from 90 degrees.

29. The human-machine interface apparatus as claimed in claim 17, wherein the third angle is an angle between roads of the vehicle location data and is 90 degrees.

30. The human-machine interface apparatus as claimed in claim 29, wherein the location system further obtains a fourth directing point according to the vision-navigation operation, and the microcontroller unit deflects the pointer to a fourth angle when the vehicle location data reaches the fourth directing point.

31. The human-machine interface apparatus as claimed in claim 30, wherein the deflected first angle makes the pointer point to the fourth directing point when the vehicle location data reaches the first directing point.

32. The human-machine interface apparatus as claimed in claim 30, wherein the deflected second angle makes the pointer point to the fourth directing point when the vehicle location data reaches the second directing point.

33. The human-machine interface apparatus as claimed in claim 29, wherein the fourth angle and the third angle are different from 90 degrees.

34. A navigation method suitable for a pointing module of a human-machine interface apparatus, the pointing module comprising a pointer, and the navigation method comprising:
providing a predetermined route;
performing a vision-navigation operation when a distance between a vehicle location data and a turning point of the predetermined route reaches a turning navigation distance;
obtaining a plurality of directing points according to the vision-navigation operation; and
deflecting the pointer to an angle when the vehicle location data reaches each of the directing points;
wherein, a deflection angle of a fore directing point is larger than a deflection angle of a back directing point which is adjacent to the fore directing point.

35. A human-machine interface apparatus configured for providing navigation information to a user according to a vehicle location data provided by a location system, the human-machine interface apparatus comprising:
a pointing module comprising a pointer; and
a microcontroller unit configured for receiving the vehicle location data provided by the location system, performing a vision-navigation operation to obtain a plurality of directing points, and deflecting the pointer to an angle when the vehicle location data reaches each of the directing points;
wherein a deflection angle of a fore directing point is larger than a deflection angle of a back directing point which is adjacent to the fore directing point.
